(19) United States
(12) Patent Application Publication
(10) Pub. No.: US 2012/0312335 A1
(43) Pub. Date: Dec. 13, 2012

(54) VACUUM DEGREASING AND CLEANING APPARATUS AND VACUUM DEGREASING AND CLEANING METHOD

(75) Inventor: Akira Sakai, Toyama-shi (JP)

(73) Assignee: NACHI-FUJIKOSHI CORP., Toyama-shi (JP)

(21) Appl. No.: 13/478,152

(22) Filed: May 23, 2012

(30) Foreign Application Priority Data
May 27, 2011 (JP) 2011-118645

(51) Int. Cl. B08B 3/02; B08B 3/14

(52) U.S. Cl. 134/34; 134/105

(57) ABSTRACT

There is provided a vacuum degreasing and cleaning apparatus, including a cleaning chamber having an injector and a sprayer that eject a solvent to an object to be cleaned, a plurality of storage tanks that store the solvent, a distiller that distills the solvent in the storage tank, and a replenisher tank that stores the solvent distilled by the distiller, wherein a heating means is provided in the inside of the sprayer in a nesting way. There is also provided a vacuum degreasing and cleaning method using the aforementioned vacuum degreasing and cleaning apparatus, wherein the solvent is pressurized and supplied to the inside of the sprayer, heated to a temperature not lower than a saturation temperature in the cleaning chamber under a reduced pressure, and thereafter sprayed in the cleaning chamber under the reduced pressure.

### BACKGROUND OF THE INVENTION

1. Field of the Invention

The present invention relates to a vacuum degreasing and cleaning apparatus which degreases and cleans mechanical parts and the like under a vacuum/reduced pressure, and a vacuum degreasing and cleaning method thereof.

2. Description of Related Art

Since oils and fats such as cutting oils and quenching oils and dusts adhere in the working processes to surfaces of metal parts for use in automobiles, construction machines, agricultural machines, the other industrial machines and the like, these adherents need to be removed before the parts are incorporated into products. In particular, when the adherents on the surfaces of parts are to be removed (degreased) by a solvent of hydrocarbon or the like, degreasing and cleaning are often performed under an atmosphere in which air is cut off, for example, under a vacuum/reduced pressure, in order to prevent the solvent from igniting.

The cleaning method under a vacuum/reduced pressure as above is often carried out by immersing an object to be cleaned into a solvent in a cleaning chamber in the past, however, the cleaning method like this has the problems of using and discarding a large amount of solvent and consumption of a large electric power from the viewpoint of an environmental aspect. Therefore, in consideration of adaptation of use of solvents to environmental protection, cleaning apparatuses and cleaning methods are developed, which inject a solvent to an object to be cleaned in a cleaning chamber by means of a sprayer and the like, or inject a vaporized solvent thereto.

For example, JP-A-2005-342639 discloses a cleaning apparatus including a plurality of cleaning nozzles movable with respect to an object to be cleaned. The apparatus is configured so that the plurality of cleaning nozzles move while being linked to one another. The respective cleaning nozzles inject a cleaning solution separately from different directions of the object to be cleaned, and therefore, can clean a plurality of surfaces of the object to be cleaned at the same time over a wide range, so that the object to be cleaned can be cleaned entirely and uniformly.

Further, JP-B2-3759439 discloses the cleaning apparatus which generates a high-temperature solvent vapor by passing a solvent through a heat exchanger, and introduces the solvent vapor into a cleaning chamber. In the cleaning process of the apparatus, degreasing of a surface of an object to be cleaned is performed in an immersing and cleaning step under vacuum by ultrasonic vibration or the like which is performed by filling a solvent in the cleaning chamber, and thereafter, cleaning is performed again by introducing a high-temperature solvent vapor into the cleaning chamber without leaving a droplet mark of the solvent on the surface of the object to be cleaned.

Further, JP-A-2005-177567 discloses the cleaning apparatus which includes a plurality of tanks which store different cleaning solutions, and cleans an object to be cleaned by sequentially using the cleaning solutions in these tanks. According to the cleaning apparatus, in the case of first to third cleaning steps, cleaning is performed by properly using the cleaning solutions in the three tanks. More specifically, the cleaning solutions for use are used by being switched from the cleaning solution with lower cleanliness to the cleaning solution with higher cleanliness in sequence in the first cleaning step through the third cleaning step, whereby cleaning of the object to be cleaned is performed while the use amount of the cleaning solution with high cleanliness is suppressed to a minimum. The cleaning solution with low cleanliness is discarded outside the tank after being used several times.

### BRIEF SUMMARY OF THE INVENTION

However, the cleaning apparatus disclosed in JP-A-2005-342639 has the problem that even though the cleaning apparatus is of the type which performs cleaning with a plurality of cleaning nozzles, in the case of objects to be cleaned in a complicated shape, uniform cleaning is difficult unless a loading method according to a certain rule is adopted. More specifically, in order to clean the objects to be cleaned uniformly, the loading method thereof is naturally determined in accordance with the shapes and the sizes of the objects to be cleaned, and therefore, there arises the problem that the loading process of the objects to be cleaned is complicated.

Further, the cleaning apparatus disclosed in Japanese Patent No. 3759439 has the problem that when the solvent is discharged outside the chamber from the cleaning chamber after immersing and cleaning with the solvent, particulate adherents such as cut dust and abrasive powder removed from the surfaces of the objects to be cleaned adhere again to the objects to be cleaned which are loaded at a lower side, and the adherents cannot be excluded even by cleaning by the solvent vapor in the post process. In addition, the cleaning apparatus has the problem that when the solvent vapor is pressure-fed via piping and valves while the solvent vapor is introduced into the cleaning chamber after being generated by the heat exchanger, the solvent vapor is cooled during that while, as a result of which, the solvent causes condensation in the piping, and the ratio of the solvent vapor introduced into the cleaning chamber to the solvent vapor generated by the heat exchanger (i.e., introduction efficiency) is reduced.

Furthermore, the cleaning apparatus and cleaning method disclosed in JPA-2005-177567 is compatible also with the cleaning method which performs oscillating and bubbling by filling a cleaning solution in a cleaning chamber, and therefore, the cleaning solution in a volumetric capacity equivalent to or larger than the volumetric capacity of the inside of the cleaning chamber or larger needs to be stockpiled in each of the tanks. Further, the cleaning apparatus has a plurality of tanks, and therefore, when the cleaning solution corresponds to a hazardous material under the law such as Fire Service Act, the cleaning apparatus shall possess the hazardous material exceeding the quantity stipulated by the law. Further, there are the problems that notifications of permissions and the like concerning installation of the cleaning apparatus, and possession and handling of the cleaning solution are complicated, and change of the installation conditions such as renovation of buildings based on the law is needed.

Thus, in the present invention, it is an object to provide a vacuum degreasing and cleaning apparatus which can efficiently introduce a solvent vapor (vaporized solvent) into a cleaning chamber. Further, it is also an object to provide a vacuum degreasing and cleaning method which can perform cleaning with a small amount of cleaning solution (solvent) irrespective of a loading method of objects to be cleaned.

In order to achieve the aforementioned objects, the present invention provides a vacuum degreasing and cleaning apparatus having a cleaning chamber having an injector and a sprayer that eject a solvent to an object to be cleaned, a plurality of storage tanks that store the solvent, a distiller that distills the solvent in the storage tank, and a replenisher tank that stores the solvent distilled by the distiller, wherein a heating means is provided in the inside of the sprayer in a nesting way. According to the present invention, the solvent which is sprayed from the sprayer is gasified (vaporized) in the cleaning chamber. Hereinafter, a configuration of the vacuum degreasing and cleaning apparatus according to the present invention will be described.

The cleaning chamber which configures the vacuum degreasing and cleaning apparatus according to the present invention has the injector and the sprayer which eject the solvent to the object to be cleaned. Further, the heating means is included in the inside of the sprayer in the nesting way. Accordingly, inside the sprayer, the solvent is passed through the inside of the nesting, and a heating medium such as a heated oil is passed through the outside of the nesting, whereby the solvent is heated. Therefore, the saturation vapor pressure of the solvent reduces at the instant when the heated solvent is released into the cleaning chamber under a reduced pressure, and therefore, the solvent which is liquid is vaporized and sprayed.

The storage tanks which configure the vacuum degreasing and cleaning apparatus according to the present invention are the tanks which store the solvent which is used to be injected and sprayed into the cleaning chamber and the solvent after use (cleaning). As the storage tanks, at least three storage tanks in total that are the first storage tank which stores the solvent which is injected to the object to be cleaned in the cleaning chamber by the injector to wash away large contaminants, the second storage tank which stores the solvent after cleaning, and the third storage tank which stores the solvent to be sprayed by the sprayer, are needed.

The distiller which configures the vacuum degreasing and cleaning apparatus according to the present invention is the device which can distill the solvent which is contaminated after cleaning and is transferred by a pressure difference from the distiller from the second tank, into a clean solvent which can be provided for cleaning again.

The replenisher tank which configures the vacuum degreasing and cleaning apparatus according to the present invention is the tank which stores the solvent which is distilled by the aforementioned distiller. The solvent in the replenisher tank is used in the final cleaning step after the object to be cleaned is cleaned by the solvent in the aforementioned first to third storage tanks, and the solvent after use is stored in any of the first to third storage tanks after being discharged from the cleaning chamber.

In the invention according to claim 2, the vacuum degreasing and cleaning apparatus is provided with a first injector that injects the solvent with a pressure of 0.1 MPa to 0.5 MPa, and a second injector that injects the solvent with a pressure of 2 MPa to 5 MPa. According to the present invention, irrespective of the loading mode of the objects to be cleaned (the shapes, the number and quantity of the objects to be cleaned, and the methods of fixing to trays and jigs, and loading), the efficiency of removal of contamination can be enhanced. Hereinafter, the first and second injectors will be described.

The first injector is the device which performs removal of contamination by a sprinkler method (shower method) by injecting the solvent to the object to be cleaned with a pressure of 0.1 MPa to 0.5 MPa, and the solvent is pressure-fed with use of a pump from the aforementioned first to third tanks. Further, the first injector can be optionally installed at positions of upper, side and bottom surfaces of the object to be cleaned in the cleaning chamber. At the same time, the first injector can be structured to be able to reciprocate freely in a vertical direction, a lateral direction and a depth direction during cleaning in the upper, side and bottom surfaces of the object to be cleaned. The reason why the lower limit of the pressure of the solvent is provided is that if the pressure is below 0.1 MPa (the pressure is too low), the proper injection state of the solvent from the nozzle of the injector is not kept, and the solvent sometimes cannot be uniformly sprayed to the object to be cleaned.

The second injector is the device which performs removal of contamination by a high-pressure method (jet method) by injecting the solvent to the object to be cleaned with a pressure of 2 MPa to 5 MPa, and the solvent is pressure-fed via a high pressure pump from the first storage tank, the third storage tank and the replenisher tank described above. Further, the second injector can be optionally installed at positions of upper, side and bottom surfaces of the object to be cleaned in the cleaning chamber similarly to the first injector. At the same time, the second injector also can be structured to be capable of reciprocating freely in a vertical direction, a lateral direction and a depth direction during cleaning in the upper, side and bottom surfaces of the object to be cleaned. The reason why the upper limit of the pressure of the solvent is provided is that it is assumed that if the pressure exceeds 5 MPa (pressure is too high), when the solvent from the nozzles of the injector collides with the object to be cleaned, the object to be cleaned is blown, and scattered from the jigs, the basket, the tray or the like in the case of a light-weight object, and the object to be cleaned collides against one another and is damaged.

In the invention according to claim 3, there is provided the vacuum degreasing and cleaning apparatus in which the plurality of storage tanks are configured by first to third storage tanks, and at least one of the storage tanks includes a heat-retaining means. Thereby, while the solvent in the other storage tank is used, the solvent in the storage tank including the heat-retaining means can be heated in advance in preparation for a next cleaning step.

In the invention according to claim 4, there is provided the vacuum degreasing and cleaning apparatus in which each of volumetric capacities of the plurality of storage tanks is smaller than a volumetric capacity of the cleaning chamber. By this, the total amount of the solvent to be used decreases as compared with the cleaning apparatus of a conventional immersing type.

As for the invention of a cleaning method, in the invention according to claim 5, there is provided a vacuum degreasing and cleaning method using the vacuum degreasing and cleaning apparatus according to any one of claims 1 to 4, in which a solvent is pressurized and supplied to the inside of the sprayer and is heated to a temperature not lower than a saturation temperature in the cleaning chamber under a reduced pressure, and thereafter, the solvent is sprayed in the cleaning chamber under the reduced pressure. According to the cleaning method according to the present invention, the solvent which is sprayed from the sprayer is gasified (vaporized) in the cleaning chamber.

The solvent is pressurized and supplied to the inside of the sprayer, and thereby can be heated by the heating means in the inside of the sprayer. After the solvent is heated to a temperature not lower than the saturation temperature of the solvent with respect to the pressure in the cleaning chamber under the reduced pressure, the solvent is sprayed into the cleaning chamber which is brought into a reduced-pressure atmosphere in advance. Since the inside of the cleaning chamber is reduced in pressure, the saturation vapor pressure in the cleaning chamber becomes lower as compared with a normal pressure, and therefore, the sprayed solvent is changed to a gaseous state (gaseous matter) from a liquid, and disperses in all directions in the cleaning chamber. For example, when a solvent which is classified in the class III petroleum in the Fire Service Act, among hydrocarbon solvents, is used, it is preferable to set the pressure applied to the solvent at 3 to 5 MPa, a heating temperature at approximately 110 to 120° C., and the pressure (absolute pressure) inside the cleaning chamber at 300 Pa or lower, in order to keep a favorable injection state.

In the invention according to claim 6, there is provided a vacuum degreasing and cleaning method using the vacuum degreasing and cleaning apparatus according to claim 3 or 4, including: a first step of injecting the solvent sucked up from the first tank to an object to be cleaned from the first or second injector, and thereafter, discharging the solvent to the second storage tank; a second step of spraying the solvent sucked up from the third storage tank to the object to be cleaned from the sprayer, and thereafter, discharging the solvent to the third storage tank, after the first step; a third step of injecting the solvent sucked up from the third storage tank to the object to be cleaned from the first or the second injector, and thereafter, discharging the solvent to the third storage tank, after the second step; and a fourth step of injecting the solvent sucked up from the replenisher tank to the object to be cleaned from the first or the second injector, and thereafter, discharging the solvent to the first storage tank, after the third step, wherein the cleaning is performed with the first to fourth steps as one cycle. According to the cleaning method according to the present invention, a large number of objects to be cleaned can be continuously cleaned by a small amount of solvent even when a long time is required for cleaning. Hereinafter, the first to fourth steps will be described in detail.

The first step is the step of injecting the solvent which is sucked up from the first storage tank to the object to be cleaned from the first injector or the second injector, and thereafter discharging the solvent after being injected to the second storage tank. The present step is the first cleaning step to the object to be cleaned, and has an object to remove large contaminants which adhere to the object to be cleaned. Further, the temperature of the object to be cleaned before cleaning is a room temperature in many cases, and the solvent can be heated by the heat-retaining means included in the first storage tank and can be provided for cleaning in order to promote cleaning performance. Furthermore, when the number of the objects to be cleaned is large, and much injection time is required, the aforementioned cleaning step may be performed by stopping supply of the solvent from the first storage tank after the injected solvent has been discharged to the second storage tank, and sucking up the solvent from the second storage tank. Further, the injected solvent which is stored in the second storage tank can be distilled by the distiller after the first step is finished.

The second step is the step of spraying the solvent which is sucked up from the third storage tank to the object to be cleaned by the sprayer, and thereafter, discharging the sprayed solvent to the third storage tank, after the aforementioned first step. The present step is the step of pressurizing and supplying the solvent which is at an ordinary temperature or heated in the third storage tank to the sprayer first, and after spraying the solvent in a mist state (atomized state) in the cleaning chamber, further heating the solvent which is heated with the heat-retaining means included in the third storage tank to a temperature not lower than a saturation temperature in the cleaning chamber under a reduced pressure by the heating means in the sprayer, thereby spreading the solvent as a gas (gaseous matter) when introducing the solvent into the cleaning chamber under the reduced pressure. By the present step, contaminants can be removed, which adhere to the portions where the contaminants cannot be removed even with the solvent from the injector in the first step, for example, to the back side of the downward blind hole which the solvent hardly reaches by injection of the solvent.

The third step is the step of injecting the solvent which is sucked up from the third storage tank to the object to be cleaned from the first injector or the second injector, and thereafter discharging the solvent to the third storage tank, after the aforementioned second step. A main object in the aforementioned first and second steps is to spread the solvent to the surfaces to be cleaned which the solvent hardly reaches by mist cleaning and vapor cleaning, and therefore, the amount of solvent which is used is small. Therefore, the case is assumed, in which the solvent containing many contaminants remains on the surfaces to be cleaned even after cleaning. Thus, in the present step, the solvent which is sucked up from the third storage tank is injected to the object to be cleaned from the first or second injector, whereby the solvent which remains on the surface of the object to be cleaned while containing a large amount of contamination after the end of the second step can be washed away. The solvent which is distilled by the distiller also can be pressure-fed to the replenisher tank during the third step or after end of the third step.

The fourth step is the step of injecting the solvent which is sucked up from the replenisher tank to the object to be cleaned from the first or second injector, and thereafter discharging the solvent to the first storage tank, after the aforementioned third step. The present step is the final step of cleaning, and the object to be cleaned is cleaned by the clean solvent which is not used or regenerated by distillation and is stored in the replenisher tank, whereby a series of cleaning steps is completed. Further, when there are a number of objects to be cleaned, and much injection time is required, supply of the solvent from the replenisher tank is stopped after the injected solvent has been discharged to the first storage tank, and the solvent is sucked up from the first storage tank, whereby the aforementioned cleaning step can be performed.

In the invention according to claim 7, there is provided the vacuum degreasing and cleaning method, in which after end of the one cycle, the first storage tank and the third storage tank are replaced, and cleaning by the next cycle is performed. According to the cleaning method according to the present invention, the cleanliness of the object to be cleaned can be more improved.

The operation of replacement of the first storage tank and the third storage tank after the end of the one cycle can be manually performed by an operator, or can be automatically performed by using programming software.

As described above, in the present invention, by the vacuum degreasing and cleaning apparatus having a cleaning chamber having an injector and a sprayer that eject a solvent to an object to be cleaned, a plurality of storage tanks that store the solvent, a distiller that distills the solvent in the storage tank, and a replenisher tank that stores the solvent distilled by the distiller, wherein a heating means is included in the inside of the sprayer in a nesting way, the solvent which is sprayed from the sprayer is gasified (vaporized) in the cleaning chamber, and therefore, the solvent vapor (vaporized solvent) can be efficiently introduced into the cleaning chamber (introduction efficiency becomes high). As a result, the solvent spreads to, for example, every corner of surfaces to be cleaned of the insides of downward blind holes which the solvent hardly reaches by the cleaning methods of sprinkling, injection, immersing and the like, and every corner of the surfaces to be cleaned can be cleaned.

Further, in the invention according to claim 2, the vacuum degreasing and cleaning apparatus is provided, which includes the first injector that injects a solvent with a pressure of 0.1 MPa to 0.5 MPa, and the second injector that injects a solvent with a pressure of 2 MPa to 5 MPa, whereby the solvent is sprayed to the object to be cleaned by the sprinkling method and the injection method, and therefore, irrespective of the loading mode of the objects to be cleaned, the efficiency of removal of contamination can be enhanced.

Further, in the invention according to claim 3, there is provided the vacuum degreasing and cleaning apparatus in which the plurality of storage tanks are configured by the first to third storage tanks, and at least one of the storage tanks includes a heat-retaining means, whereby the solvent in the storage tank can be wormed before cleaning, and therefore, the cleaning effect for the object to be cleaned can be enhanced while the cleaning time can be shortened.

Further, in the invention according to claim 4, there is provided the vacuum degreasing and cleaning apparatus in which each of volumetric capacities of the plurality of storage tanks is smaller than a volumetric capacity of the cleaning chamber, whereby the total amount of the solvent which is used is reduced as compared with the cleaning apparatus of the conventional immersing type, and therefore, downsizing of the apparatus can be realized by suppressing increase in the volumetric capacity of the entire apparatus and the installation area. Further, as the result of reduction in the total amount of the solvent to be used, notification and application to offices (municipalities) based on the law are not required or become simple, and at the same time, introduction of the cleaning apparatus is enabled without changing the building structure and the like.

As for the invention relating to the vacuum degreasing and cleaning method, in the invention according to claim 5, by the vacuum degreasing and cleaning method using the vacuum degreasing and cleaning apparatus according to any one of claims 1 to 4, in which a solvent is pressurized and supplied to the inside of the sprayer and is heated to a temperature not lower than a saturation temperature in the cleaning chamber under a reduced pressure, and thereafter, the solvent is sprayed into the cleaning chamber under the reduced pressure, the solvent which is sprayed from the sprayer is gasified (vaporized) in the cleaning chamber. Therefore, the gasified solvent spreads to every corner in the cleaning chamber, and for example, even the back sides of the insides of the downward blind holes which the solvent hardly reaches with cleaning methods of sprinkling, injection, immersing and the like can be cleaned.

Further, in the invention according to claim 6, by a vacuum degreasing and cleaning method using the vacuum degreasing and cleaning apparatus according to claim 3 or 4, including: the first step of injecting the solvent sucked up from the first storage tank to the object to be cleaned from the first or the second injector, and thereafter, discharging the solvent to the second storage tank; the second step of spraying the solvent sucked up from the third storage tank to the object to be cleaned from the sprayer, and thereafter, discharging the solvent to the third storage tank, after the first step; the third step of injecting the solvent sucked up from the third storage tank to the object to be cleaned from the first or second injector, and thereafter, discharging the solvent to the third storage tank, after the second step; and the fourth step of injecting the solvent sucked up from the replenisher tank to the object to be cleaned from the first or second injector, and thereafter, discharging the solvent to the first storage tank, after the third step, wherein the cleaning is performed with the first to fourth steps as one cycle, the cleaning can be performed by a small amount of solvent even in the case of continuous cleaning of a large number of objects to be cleaned, and therefore, downsizing of the apparatus can be realized by suppressing increase in the volumetric capacity of the entire apparatus and the installation area.

Further, in the invention according to claim 7, by the vacuum degreasing and cleaning method in which after end of the one cycle, the first storage tank and the third storage tank are replaced, and the cleaning by the next cycle is performed, the cleanliness of the object to be cleaned is improved, and therefore, the cleaning with high quality is always enabled irrespective of the number of cycles (cumulative number of cleaning times).

### BRIEF DESCRIPTION OF THE SEVERAL VIEWS OF THE DRAWING

FIG. 1 is a schematic view of an entire vacuum degreasing and cleaning apparatus 1 according to the present invention;

FIG. 2 is a vertical sectional view of a cleaning chamber 4 which configures the vacuum degreasing and cleaning apparatus 1 according to the present invention;

FIG. 3A is a vertical sectional view of a sprayer 3 provided in the cleaning chamber 4 which configures the vacuum degreasing and cleaning apparatus 1;

FIG. 3B is a sectional view taken along line A-A of FIG. 3A;

FIG. 4 is a schematic view showing a first step of a vacuum degreasing and cleaning method according to the present invention;

FIG. 5 is a schematic view showing switch of storage tanks (a first storage tank 5a to a second storage tank 5b) which is used in the first step of the vacuum degreasing and cleaning method according to the present invention;

FIG. 6 is a schematic view showing pressure-feed of a solvent in the second storage tank 5b to a distiller 6 in the first step of the vacuum degreasing and cleaning method according to the present invention;

FIG. 7 is a schematic view showing a second step of the vacuum degreasing and cleaning method according to the present invention;

FIG. 8 is a schematic view showing a third step of the vacuum degreasing and cleaning method according to the present invention;

FIG. 9 is a schematic view showing a fourth step of the vacuum degreasing and cleaning method according to the present invention;

FIG. 10 is a schematic view showing switch of storage tanks (a replenisher tank 7 to the first storage tank 5a) which is used in the fourth step of the vacuum degreasing and cleaning method according to the present invention;

FIG. 11 is a schematic view of work shapes and a packing mode of specimen A which is used in a cleaning test of the present example;

FIG. 12 is a schematic view of work shapes and a packing mode of specimen B which is used in the cleaning test of the present example;

FIG. 13 is a schematic view of work shapes and a packing mode of specimen C which is used in the cleaning test of the present example; and

FIG. 14 is a schematic side view of work shapes and a packing mode of specimen D which is used in a cleaning test of the present example.

### DETAILED DESCRIPTION OF THE INVENTION

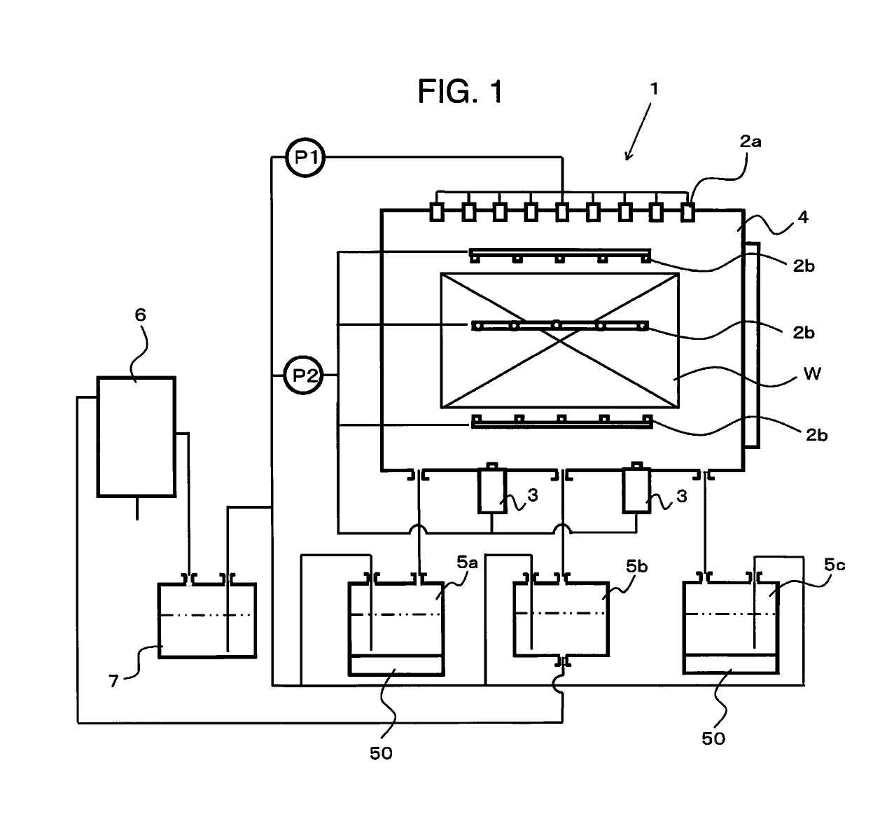

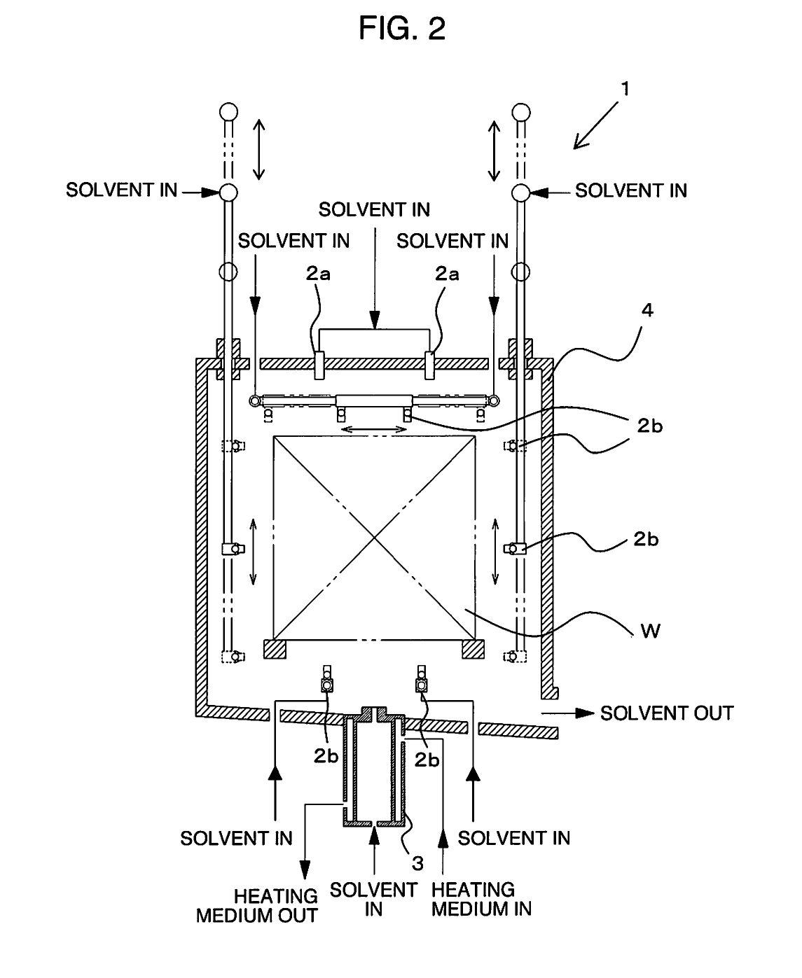

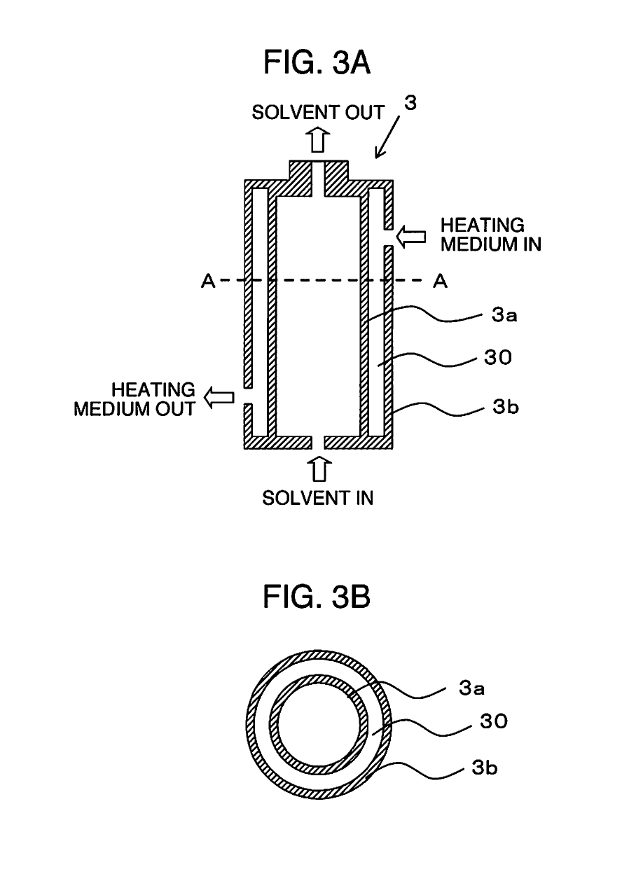

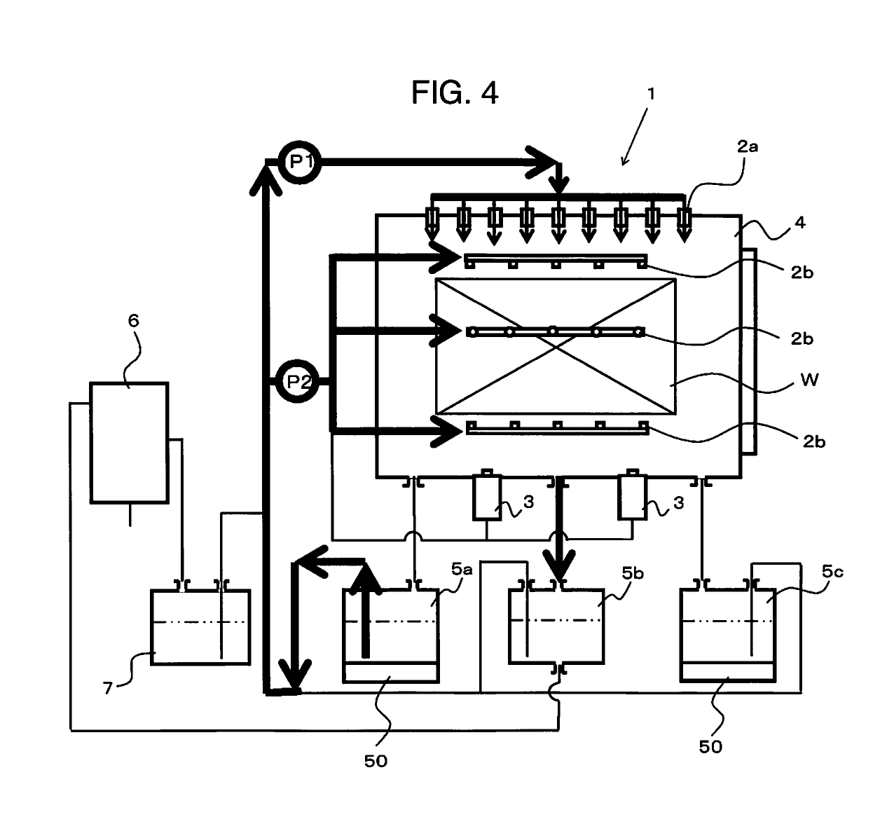

Concerning an example of an embodiment of the present invention, a vacuum degreasing and cleaning apparatus according to the present invention will be described with reference to the drawings. FIG. 1 is a schematic view of an entire vacuum degreasing and cleaning apparatus 1 according to the present invention. FIG. 2 is a vertical sectional view of a cleaning chamber 4 which configures the vacuum degreasing and cleaning apparatus 1 according to the present invention. FIG. 3A is a vertical sectional view of a sprayer 3 included by the cleaning chamber 4 which configures the vacuum degreasing and cleaning apparatus 1, and FIG. 3B is a sectional view taken along line A-A of FIG. 3A.

As shown in FIGS. 1 and 2, the vacuum degreasing and cleaning apparatus 1 has a cleaning chamber 4 having injectors 2a and 2b and sprayers 3 which eject a solvent to an object W to be cleaned, a plurality of storage tanks 5a to 5c which store the solvent, a distiller 6 which distills the solvent in the storage tank 5b, and a replenisher tank 7 which stores the solvent distilled by the distiller 6. Further, as shown in FIG. 3, a heating means 30 is included inside the sprayer 3 in a nesting way. Furthermore, the injectors are configured by the first injector 2a which injects the solvent with a pressure of 0.1 MPa to 0.5 MPa, and the second injector 2b which injects the solvent with a pressure of 2 MPa to 5 MPa. The arrows in FIG. 2 show flows (inflow and outflow) of the solvent or a heating medium.

The first injector 2a is a device which performs removal of contamination by a sprinkler method (shower method) by injecting the solvent to the object W to be cleaned with a pressure of 0.1 MPa to 0.5 MPa, and the solvent is pressure-fed with use of a pump P1 from the first to the third tanks 5a to 5c which will be described later. Further, the first injector 2a can be optionally installed at a position of an upper surface of the object W to be cleaned in the cleaning chamber 4 as shown in FIG. 2.

The second injector 2b is a device which performs removal of contamination by a high-pressure method (jet method) by injecting the solvent to the object W to be cleaned with a pressure of 2 MPa to 5 MPa, and the solvent is pressure-fed via a high pressure pump P2 from the first tank 5a, the third tank 5c and the replenisher tank 7. Further, the second injector 2b can be optionally installed at positions of upper, side and bottom surfaces of the object W to be cleaned in the cleaning chamber 4, unlike the first injector 2a as shown in FIG. 2. At the same time, the second injector 2b also can be structured to be capable of reciprocating freely in a vertical direction, a lateral direction and a depth direction during cleaning in the upper, side and bottom surfaces of the object W to be cleaned.

The sprayer 3 is a device which performs removal of contamination by spraying the solvent in a liquid form or in a vaporized (vapor) state and spreading the solvent to the entire surface of the object W to be cleaned. As shown in FIG. 3A, the heating means 30 which can heat the solvent by inflow and outflow of a heating medium is provided in an inside of the sprayer 3 in a nesting way. Further, as shown in FIG. 3B, a section of the sprayer 3 is configured by an inner cylinder portion 3a and an outer cylinder portion 3b, and the solvent can be heated by flowing the solvent inside the inner cylinder portion 3a in a state in which the heating medium is passed into a clearance portion between the inner cylinder portion 3a and the outer cylinder portion 3b, that is, into a portion of the heating means 30. As the heating medium, a synthetic or mineral heating medium oil and heating steam can be used. The arrows in FIG. 3A show the flows (inflow and outflow) of the solvent or the heating medium.

The cleaning chamber 4 has the first injectors 2a, the second injectors 2b and the sprayers 3 which eject the solvent to the object W to be cleaned. The heating means 30 is included inside the sprayer 3 in the nesting way as described above. Further, when the second injector 2b is made movable freely in the height direction (vertical direction) of the cleaning chamber with respect to the object W to be cleaned, an upper portion of a pipe which pressure-feeds the solvent to the second injector 2b protrudes outside the cleaning chamber 4, but the cleaning chamber 4 is structured so that air tightness is sufficiently kept even in such a case. Furthermore, a floor surface of the cleaning chamber 4 is inclined (provided with a gradient), and is structured so that the solvent after cleaning naturally flows down and can be discharged to the storage tanks 5a to 5c outside the cleaning chamber 4.

The storage tanks 5a to 5c are tanks which store the solvent to be used to be injected and sprayed into the cleaning chamber and the solvent after being used (cleaning). As the storage tanks, at least three storage tanks in total that are the first storage tank 5a which stores the solvent which is injected to the object to be cleaned in the cleaning chamber by the injector to clean large contaminants, the second storage tank 5b which stores the solvent after cleaning, and the third storage tank 5c which stores the solvent to be sprayed by the sprayer, are needed. Further, the storage tanks 5a and 5c include heat-retaining means 50, and thereby can heat the solvent in the storage tanks 5a and 5c including the heat-retaining means 50 in advance in preparation for the next cleaning step while the solvent in the other storage tank 5b is being used. Each of the volumetric capacities of the storage tanks 5a to 5c is smaller than the volumetric capacity of the cleaning chamber 4.

The distiller 6 is a device which can distill the solvent which is contaminated after cleaning, and is transferred by a pressure difference from the distiller 6, from the second tank 5b to a clean solvent which can be provided for cleaning again. Further, the replenisher tank 7 is a tank which stores the solvent which is distilled by the distiller 6. The solvent in the replenisher tank 7 is used in the final cleaning step after the object W to be cleaned is cleaned by the solvent in the first to the third storage tanks 5a to 5c, and the solvent after being used is stored in any of the first to the third storage tanks 5a to 5c after being discharged from the cleaning chamber 4.

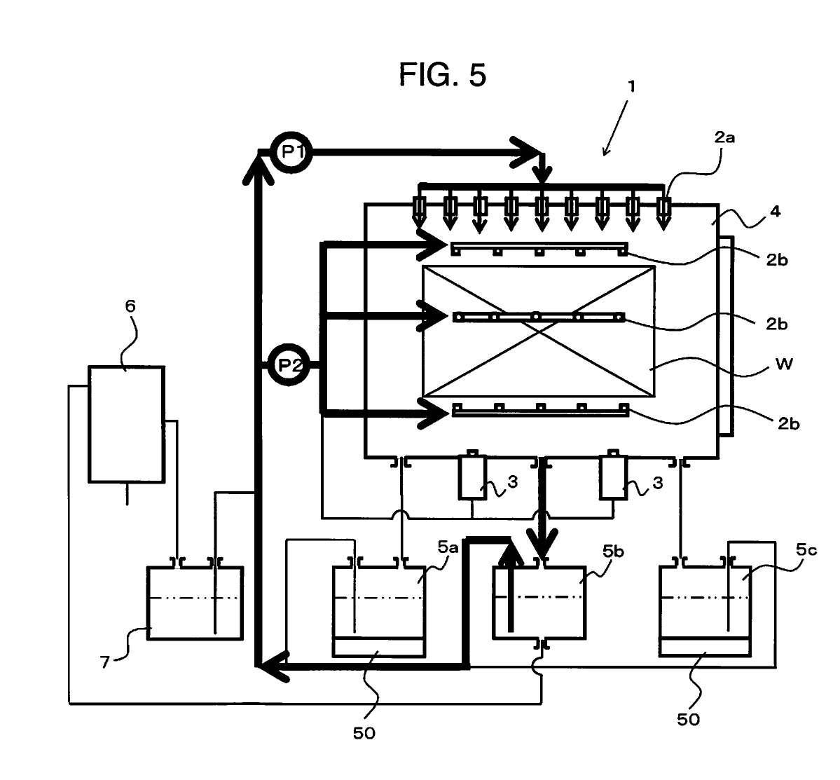

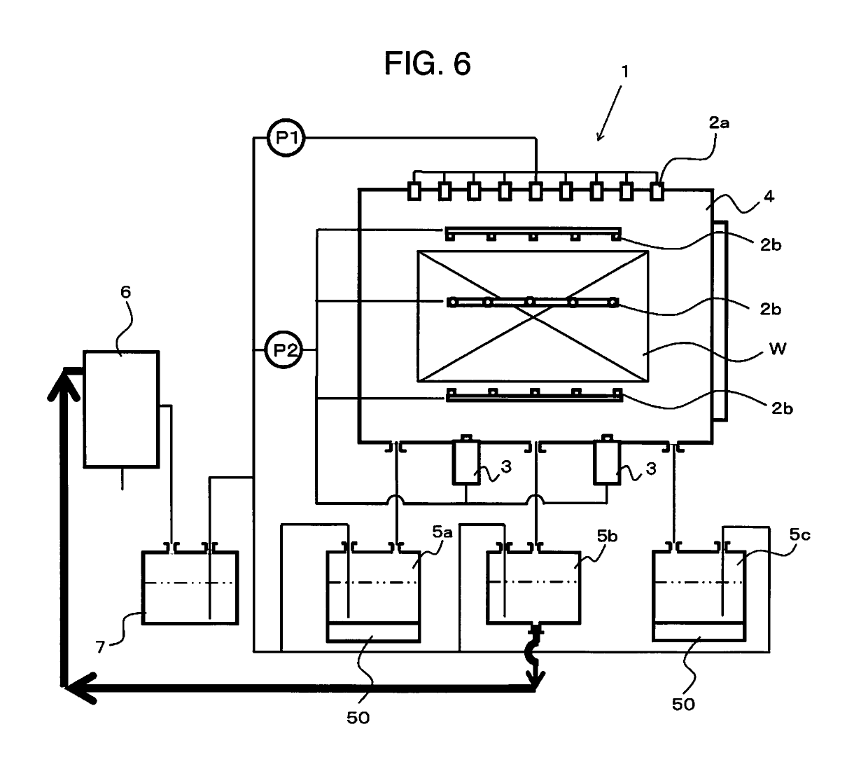

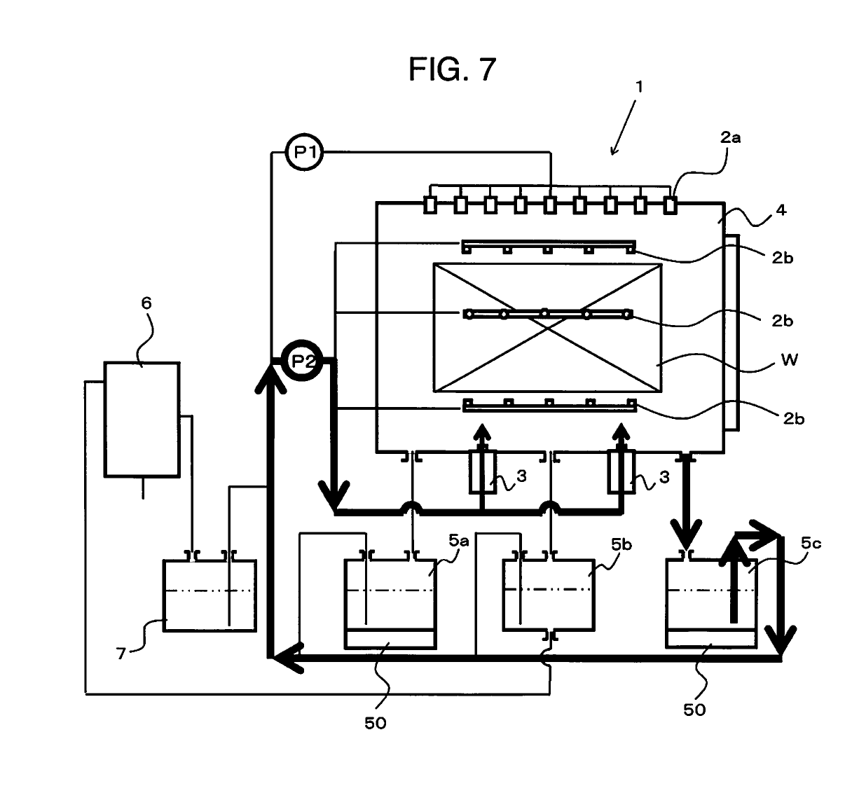

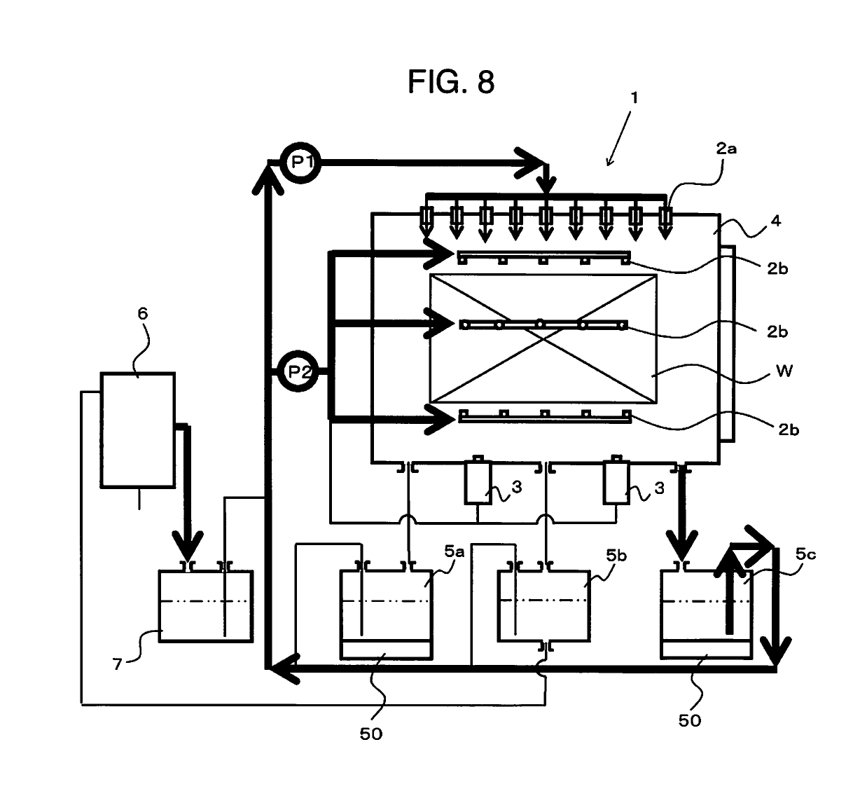

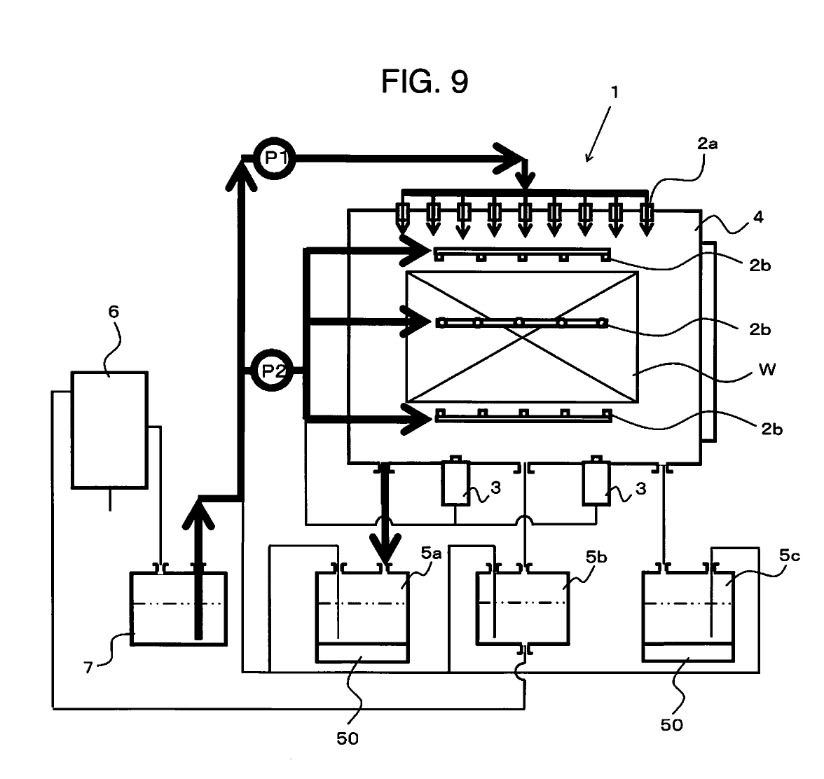

Next, a procedure of a vacuum degreasing and cleaning method according to the present invention will be described with use of FIG. 4 to FIG. 10. FIG. 4 is a schematic view showing a first step of the vacuum degreasing and cleaning method according to the present invention. FIG. 5 is a schematic view showing switch of the storage tanks (the first storage tank 5a to the second storage tank 5b) which is used in the first step of the same method. FIG. 6 is a schematic view showing pressure-feed of a solvent in the second storage tank 5b to the distiller 6 in the first step of the same method. FIG. 7 is a schematic view showing a second step of the same method. FIG. 8 is a schematic view showing a third step of the same method. FIG. 9 is a schematic view showing a fourth step of the same method. FIG. 10 is a schematic view showing switch of the storage tanks (the replenisher tank 7 to the first storage tank 5a) which is used in the fourth step of the same method. The arrows in FIG. 4 to FIG. 10 show the flows (inflow and outflow) of the solvent.

The first step is the step of injecting the solvent which is sucked up from the first storage tank 5a to the object W to be cleaned from the first injectors 2a or the second injectors 2b via the pump P1 and the high-pressure pump P2, and thereafter discharging the solvent after being injected to the second storage tank 5b, as shown in FIG. 4. Further, the temperature of the object W to be cleaned before cleaning is a room temperature in many cases, and the solvent can be heated by the heat-retaining means 50 included in the first storage tank 5a and provided for cleaning in order to promote cleaning performance. Furthermore, when the number of the objects W to be cleaned is large, and a long injection time is required, the present step may be performed by stopping supply of the solvent from the first storage tank 5a after the injected solvent has been discharged to the second storage tank 5b, and then sucking up the solvent from the second storage tank 5b to continue cleaning, as shown in FIG. 5. Further, the injected solvent which is stored in the second storage tank 5b can be distilled by being pressure-fed to the distiller 6 after the first step is finished, as shown in FIG. 6.

The second step is the step of spraying the solvent which is sucked up from the third storage tank 5c to the object W to be cleaned by the sprayer 3 via the high-pressure pump P2, and thereafter, discharging the sprayed solvent to the third storage tank 5c, after the first step, as shown in FIG. 7. The present step is the step of pressurizing and supplying the solvent which is at a room temperature or is heated in the storage tank 5c first, and after spraying the solvent in a mist form (atomized state) in the cleaning chamber 4, further heating the solvent which is heated with the heat-retaining means 50 included in the third storage tank 5c to a temperature not lower than a saturation temperature in the cleaning chamber 4 under a reduced pressure by the heating means 30 in the sprayer 3, thereby dispersing the solvent as a gas (gaseous matter) when the solvent is introduced into the cleaning chamber 4 under the reduced pressure.

The third step is the step of injecting the solvent which is sucked up from the third storage tank 5c to the object W to be cleaned from the first injector 2a or the second injector 2b via the pump P1 and the high-pressure pump P2, and thereafter discharging the solvent to the third storage tank 5c, after the second step as shown in FIG. 8. Further, the solvent which is distilled in the distiller 6 in the first step can be pressure-fed to the replenisher tank 7.

The fourth step is the step of injecting the solvent which is sucked up from the replenisher tank 7 to the object W to be cleaned from the first injector 2a or the second injector 2b, and thereafter discharging the solvent to the first storage tank 5a, after the third step as shown in FIG. 9. The present step is the final cleaning step, and the object W to be cleaned is cleaned by the clean solvent which is not used or regenerated by distillation and stored in the replenisher tank 7, whereby a series of cleaning steps is completed. Further, when there are a large number of objects W to be cleaned, and a long injection time is required, the present step may be performed by stopping supply of the solvent from the replenisher tank 7 after the injected solvent has been discharged to the first storage tank 5a, and sucking up the solvent from the first storage tank 5a to continue cleaning, as shown in FIG. 10.

### Example

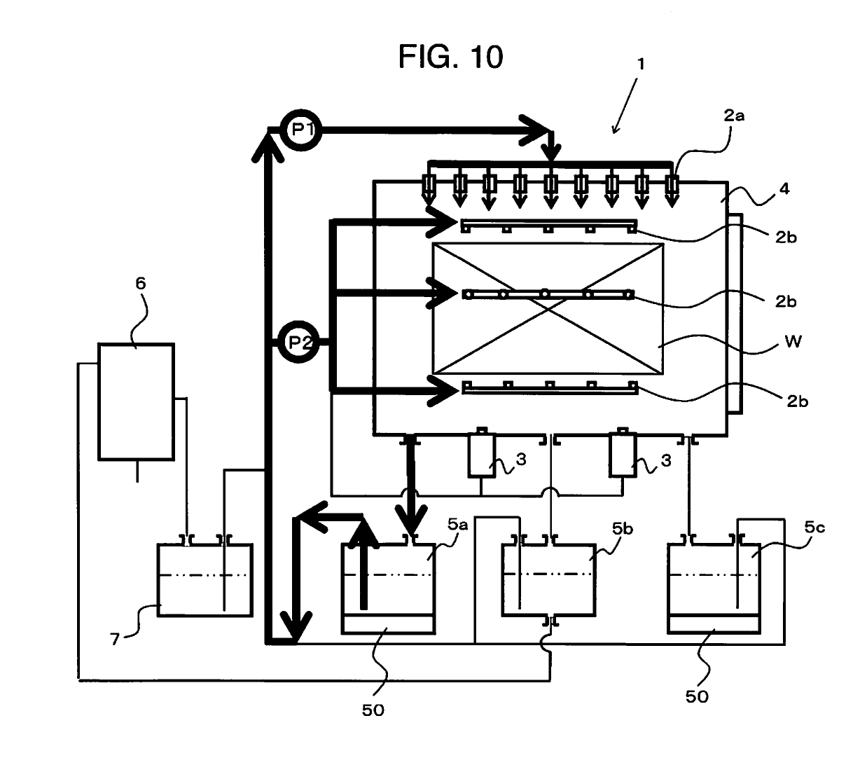

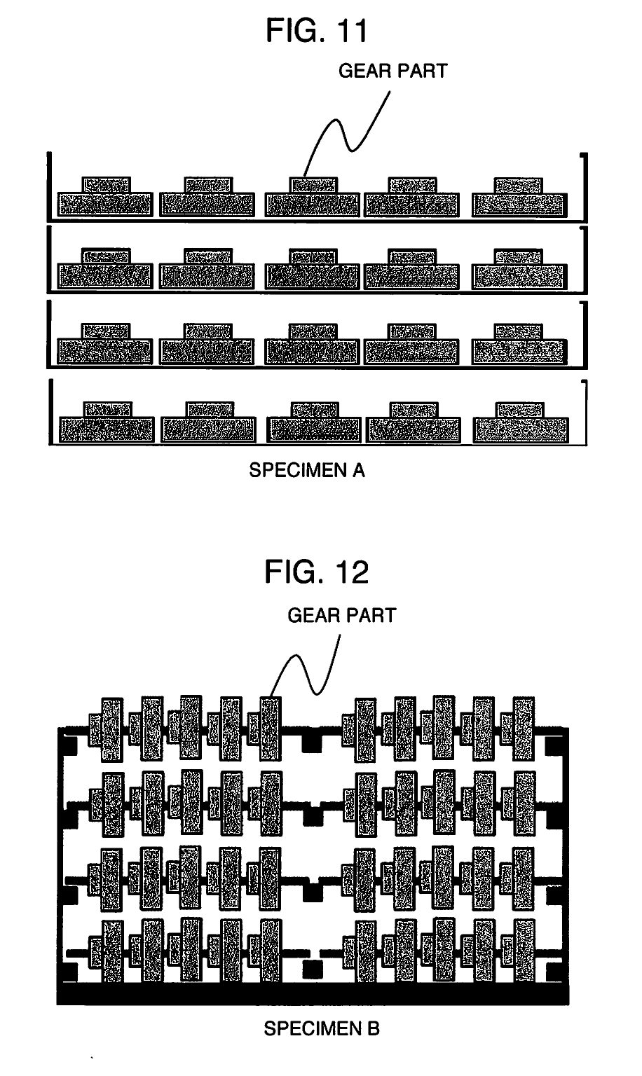

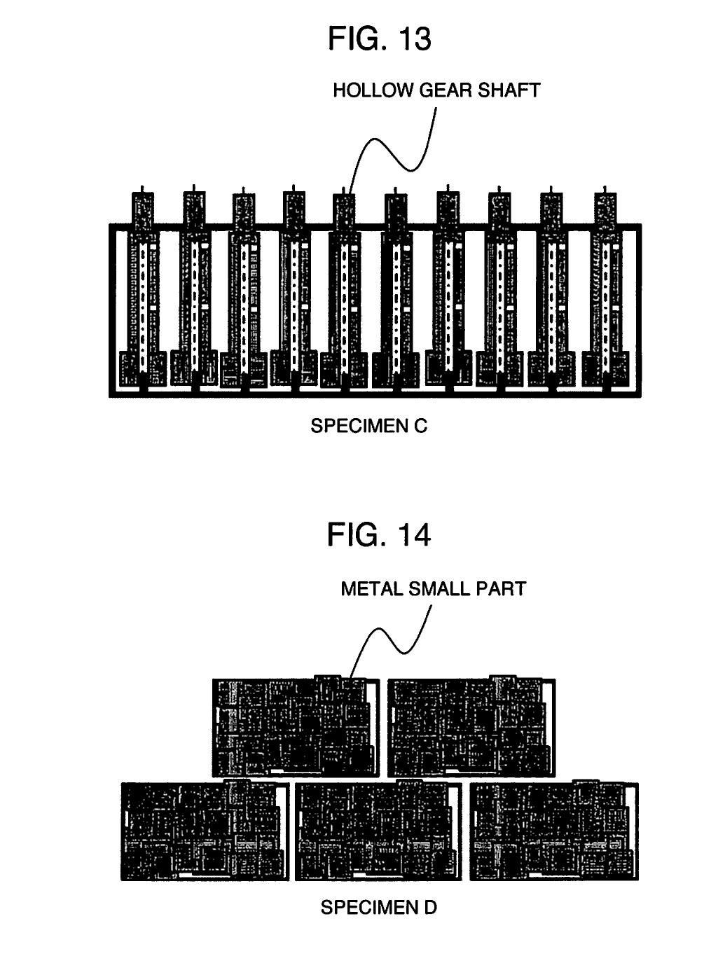

Since a cleaning test for four kinds of specimens (the objects W to be cleaned) which differ in shapes and loading modes from one another was performed by using the vacuum degreasing and cleaning apparatus 1 of FIG. 1 which is shown in the embodiment of the present invention, the test result will be described by using FIG. 11 to FIG. 14. FIG. 11 is a schematic view of the work shapes and the loading mode of a specimen A which was used in the cleaning test of the present example. FIG. 12 is a schematic view of the work shapes and the loading mode of a specimen B which was used in the same test. FIG. 13 is a schematic view of the work shapes and the loading mode of a specimen C which was used in the same test. FIG. 14 is a schematic view of the work shapes and the loading mode of a specimen D which was used in the same test. In regard to the cleaning result, degreasing, drying, and presence/absence of remaining particulate contaminants were visually evaluated.

The specimens which were cleaned will be described. The specimens used in the present test are four kinds of the following specimens A to D in total, which are shown in FIG. 11 to FIG. 14, and all the specimens differ from one another in work shapes and loading modes.

The specimen A was such that gear parts were flatly placed on a multistage basket as shown in FIG. 11, and a number of contaminants adhered to the front surfaces and back surfaces (undersides) of the gear parts. The dimensions of the entire specimen were a width of 760 mm, a depth of 760 mm, and a height of 760 mm, and the total weight including the weights of the trays and baskets was set at approximately 250 kg.

The specimen B was such that gear parts were systematically placed by using jigs in a state in which rods were equidistantly passed through the central hole portions of the gear parts as shown in FIG. 12. Further, similarly to the specimen A, a number of contaminants adhered to the front surfaces and the back surfaces (undersides) of the gear parts. The dimensions of the entire specimen were a width of 760 mm, a depth of 610 mm, and a height of 760 mm, and the total weight including the weights of the trays and baskets was set at approximately 250 kg.

The specimen C was such that hollow gear shafts were systematically arranged by using jigs in a state in which the through-holes of the hollow gear shafts were laid face down (the state in which worked hole portions were turned down) as shown in FIG. 13. The dimensions of the entire specimen were a width of 760 mm, a depth of 610 mm, and a height of 400 mm, and the total weight including the weights of the trays and baskets was set at approximately 250 kg.

The specimen D had the loading mode in which a plurality of baskets were stacked, in which metal small parts were indiscriminately filled and the parts were densely packed as shown in FIG. 14. The dimensions of the entire specimen was a width of 760 mm, a depth of 1220 mm, and a height of 300 mm, and the total weight including the weights of the trays and baskets was set at approximately 250 kg. Each of the specimens before cleaning was in a cool temperature (room temperature) state, a contaminant (quenching oil with a high viscosity was used) was caused to adhere uniformly to the surface of each of the specimens. After oil drain by free-fall drop was over, each of the specimens was charged into the vacuum degreasing and cleaning apparatus according to the present invention, and cleaning was performed.

Next, a cleaning method will be described. A cleaning step adopted a cleaning pattern using a combination of shower (sprinkling), injection, spraying (mist), and vaporization and introduction (vapor) of the solvent. Respective step times were, in sequence of the steps, decompression of the inside of the cleaning chamber (optional), 100 seconds for shower of the solvent by the first injector, 100 seconds for introduction of a liquid solvent by the sprayer, 180 seconds for introduction of the vaporized solvent by the sprayer, 100 seconds for solvent injection by the second injector, 420 seconds for shower of the heated solvent by the first injector, 100 seconds for final cleaning by the first injector and the second injector, 420 seconds for vacuum drying, and pressure restoration of the inside of the cleaning chamber (optional). Further, in the shower step and the final cleaning step, either the first or the second injector that was considered as optimal was selected and used for each work. The cleaning result of the respective specimens A to D will be described as follows.

In regard to the specimen A, since it was assumed that with shower of the solvent by the first injector from above, the solvent did not directly reach the underside of the works and the top surfaces of the works in the lower stage of the basket, in the aforementioned cleaning pattern, cleaning was performed by the second injector (movable type). As a result, there was no remaining contaminant and undried portion on the surfaces to be cleaned on the undersides of the works and the top surfaces of the works, and the cleaned state was favorable. Further, reattachment of particulate contaminants was not confirmed, either. The reason why the degreasing effect was found with respect to the bottom surfaces of the works and the works in the basket in the lower stage is considered to be due to the effects of injection of the solvent by the second injector from the work side surface direction, and the solvent sprayed by the sprayer from the bottom surface of the cleaning chamber to the upper side to be vaporized and introduced, and due to absence of the particulate contaminants, which had been shaken off from the surfaces to be cleaned by the injector, floating around the works. Therefore, with respect to the degreasing effect of oil and grease contamination and the removal effect of particulate contaminants, the cleaning effect that was equivalent or higher as compared with an immersing method was obtained.

In regard to the specimen B, since it was assumed that in the aforementioned cleaning pattern, the solvent uniformly reached the work with shower from above by the first injector, and that with high-pressure injection by the second injector, the works were moved by the injection pressure and were damaged, cleaning by the first injector was performed. As a result, a remaining contaminant and an undried portion were not found favorably irrespective of the set position, and reattachment of particulate contaminants was not able to be confirmed. The reason thereof is considered to be the facts that the spaces between the works were large and that the solvent sprinkled with the first injector from above was sufficiently spread to the works set in the lower stage, the effect of the solvent which was sprayed to the upper side from the bottom surface of the cleaning chamber by the sprayer to be vaporized and introduced, and absence of particulate contaminants, which were shaken off from the surface to be cleaned by the first injector, floating around the works. Consequently, with respect to the degreasing effect of oil and grease contamination and the removal effect of particulate contaminants, the cleaning effect which was equivalent or higher as compared with an immersing method was obtained.

In regard to the specimen C, since it was assumed that in the aforementioned cleaning pattern, the solvent uniformly reached the works with shower by the first injector from above, and that with high-pressure injection by the second injector, the works were moved by the injection pressure and were damaged, cleaning from the first injector was performed. As a result, there was no remaining contaminant and undried portion on the surfaces to be cleaned of the work outer surfaces irrespective of the set position, favorably. Reattachment of particulate contaminants was not able to be confirmed, and remaining contamination and drying of the hollow portions were also favorable. The reason thereof is considered to be the fact that the solvent was sufficiently spread to the work outer surfaces with only the shower by the first injector, the effect of the solvent which was sprayed to the upper side from the bottom surface of the cleaning chamber by the sprayer to be vaporized and introduced, with respect to the hollow portions, and absence of particulate contaminants, which were shaken off from the surfaces to be cleaned by the first injector, floating around the works. Consequently, in regard to cleaning of the hollow portions (downward blind holes), the effect which is higher than an immersing method was obtained. Further, it is assumed that when the works are placed in multiple stages which are two stages or more, a favorable cleaning result is obtained by performing cleaning while adjusting the injection pressure by using the second injector in place of the first injector.

In regard to the specimen D, contaminants need to be washed away sequentially from the upper portions of the works to the lower portions by applying the solvent uniformly to the work top surfaces in the aforementioned cleaning pattern, and therefore, cleaning by the shower of the first injector was performed. As a result, a remaining contaminant and an undried portion on the surfaces to be cleaned which were set to the deep positions of the upper stage and the lower stage were not found, favorably. The reason thereof is considered to be due to the effects of washing from the upper sides of the works to the lower sides by the sprinkling by the first injector, and the solvent which was sprayed upward from the bottom surface of the cleaning chamber by the sprayer to be vaporized and introduced. In regard to removal of particulate contaminants, it is assumed that since the works are densely charged in the baskets, the adherents on the works on the upper parts are removed, and thereafter, are highly likely to adhere to the works at the lower parts, and therefore, the result is considered to be equivalent to reattachment of particulate contaminants by using an immersing method.

In the present example, the case of three storage tanks is described, but it goes without saying that even in the case with four or more storage tanks (a fourth tank, a fifth tank and the like), the same effect can be obtained. In the case of use of four or more storage tanks, the storage tank which is in charge of transfer of the contaminated solvent to the distiller is only the second storage tank as in the case of use of three storage tanks.

The variation of transfer and storage of the solvent among the respective storage tanks in the case of use of four or more storage tanks is as follows. The solvent in the replenisher tank is used in the final cleaning step after the object to be cleaned is cleaned by the solvent in the aforementioned first to the third storage tank and the fourth and the following storage tanks, and the solvent after being used is stored in the first, the second and the fourth and the following storage tanks after being discharged from the cleaning chamber.

For example, as a transfer example of the solvent, the solvent is sucked up with the pump from the first storage tank in the first cleaning step (the first step), and is transferred to the cleaning chamber. The solvent which is injected, sprayed or introduced as vapor to the cleaning chamber is discharged to and stored in the second storage tank. The contaminated solvent which is stored in the second storage tank is transferred to the distiller, and the solvent which is distilled and regenerated is transferred to and stored in the replenisher tank. In the next cleaning step (the second step), the solvent is sucked up by the pump from the third storage tank, and is transferred to the cleaning chamber. The solvent which is injected, sprayed, or introduced as vapor into the cleaning chamber is discharged to and stored in the first storage tank. In the next cleaning step (the third step), the solvent is sucked up from the fourth storage tank with the pump, and is transferred to the cleaning chamber. The solvent which is injected, sprayed or introduced as vapor into the cleaning chamber is discharged to and stored in the third storage tank. In the final cleaning step (the fourth step), the solvent is sucked up from the replenisher tank with the pump, and is transferred to the cleaning chamber. The solvent which is injected, sprayed or introduced as vapor into the cleaning chamber is discharged to and stored in the fourth storage tank.

More specifically, even when the number of storage tanks is increased to four or more, the solvent which is used in the first cleaning step (the first step) is discharged to the second storage tank from the cleaning chamber, and after being transferred to the distiller to be distilled and regenerated, the solvent can be transferred to the replenisher tank. Further, in the final cleaning step (the fourth step), the solvent is sucked up from the replenisher tank by the pump and is transferred to the cleaning chamber, and the solvent which is injected, sprayed or introduced as vapor is discharged to and can be stored in the fourth and the following storage tanks.

1. A vacuum degreasing and cleaning apparatus, comprising:
a cleaning chamber having an injector and a sprayer that eject a solvent to an object to be cleaned;
a plurality of storage tanks that store the solvent;
a distiller that distills the solvent in the storage tanks; and
a replenisher tank that stores the solvent distilled by the distiller, wherein a heating means is provided in the inside of the sprayer in a nesting way.

2. The vacuum degreasing and cleaning apparatus according to claim 1, wherein the injector comprises a first injector that injects the solvent with a pressure of 0.1 MPa to 0.5 MPa, and a second injector that injects the solvent with a pressure of 2 MPa to 5 MPa.

3. The vacuum degreasing and cleaning apparatus according to claim 1, wherein the plurality of storage tanks comprise first to third storage tanks, and at least one of the storage tanks comprises a heat-retaining means.

4. The vacuum degreasing and cleaning apparatus according to claim 1, wherein each of volumetric capacities of the plurality of storage tanks is smaller than a volumetric capacity of the cleaning chamber.

5. A vacuum degreasing and cleaning method, using the vacuum degreasing and cleaning apparatus according to claim 1, wherein the solvent is pressurized and supplied to the inside of the sprayer and is heated to a temperature not lower than a saturation temperature in the cleaning chamber under a reduced pressure, and thereafter, the solvent is sprayed into the cleaning chamber under the reduced pressure.

6. A vacuum degreasing and cleaning method, using the vacuum degreasing and cleaning apparatus according to claim 3, including:
a first step of injecting the solvent sucked up from the first tank to an object to be cleaned from the first or second injector, and thereafter, discharging the solvent to the second tank;
a second step of spraying the solvent sucked up from the third tank to the object to be cleaned from the sprayer, and thereafter, discharging the solvent to the third tank, after the first step;
a third step of injecting the solvent sucked up from the third tank to the object to be cleaned from the first or second injector, and thereafter, discharging the solvent to the third tank, after the second step; and
a fourth step of injecting the solvent sucked up from the replenisher tank to the object to be cleaned from the first or second injector, and thereafter, discharging the solvent to the first tank, after the third step, wherein
the cleaning is performed with the first to fourth steps as one cycle.

7. The vacuum degreasing and cleaning method according to claim 6, wherein after end of the one cycle, the first tank and the third tank are replaced, and then the cleaning of a next cycle is performed.
